(19) United States
(12) Patent Application Publication
(10) Pub. No.: US 2008/0005787 A1
(43) Pub. Date: Jan. 3, 2008

(54) Software Distribution and License Management System

(75) Inventor: Terrence Aldred, Douglassville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS MEDICAL SOLUTIONS USA, INC., MALVERN, PA (US)

(21) Appl. No.: 11/749,345

(22) Filed: May 16, 2007

Related U.S. Application Data
(60) Provisional application No. 60/805,996, filed on Jun. 28, 2006.

(51) Int. Cl. H04L 9/32; G06F 9/44

(52) U.S. Cl. 726/4; 717/172

(57) ABSTRACT

A system automatically distributes software to users and automatically initiates reclaiming of unneeded software licenses and updates a license tracking database without manual intervention. An automated software license management system includes at least one repository of information identifying licensed users of an executable application. A message generator automatically initiates generation of a prompt message for communication to a user prompting a user to affirm continued need to use the executable application in response to a predetermined event. An interface receives answer data in response to the prompt message. A license management processor updates the information in the at least one repository to indicate a user is no longer licensed to use the executable application in response to the received answer data.

This is a non-provisional application of provisional application Ser. No. 60/805,996 by T. Aldred filed Jun. 28, 2006.

### FIELD OF THE INVENTION

This invention concerns an automated software license management system enabling a user to acquire a software license and associated software and relinquish an unused software license and associated software.

### BACKGROUND OF THE INVENTION

In known software distribution and license management systems, a user needs to expend a burdensome amount of time in granting access to software and associated storage folders for downloading software or in initiating software distribution via a third party software application distribution system. Specifically, a user expends time in recording disbursement of a license to a requestor or in reclaiming a license no longer needed Further, determining whether or not software licenses held by individuals are still needed requires burdensome interrogation and querying activity. This activity is often performed infrequently, if at all, which results in an inaccurate and excessive number of licenses being acquired and paid for.

Known systems typically employ manual effort in managing grant and reclamation of software licenses, using a spreadsheet or rudimentary database, for example, to track licenses, requests for software, the software distributed, and use of that software on a user workstation. Known systems also involve manual software request and order fulfillment and manual annual license tracking. A system according to invention principles addresses these deficiencies and related problems.

### SUMMARY OF THE INVENTION

A system automatically distributes software to users without manual intervention by evaluating requests, determining authorization status of a user, concurrently indicating software that is already licensed to the user and requiring the user to affirm continued need of licenses and distributing requested software to authorized users. An automated software license management system includes at least one repository of information identifying licensed users of an executable application. A message generator automatically initiates generation of a prompt message for communication to a user prompting a user to affirm continued need to use the executable application in response to a predetermined event. An interface receives answer data in response to the prompt message. A license management processor updates the information in the at least one repository to indicate a user is no longer licensed to use the executable application in response to the received answer data.

### BRIEF DESCRIPTION OF THE DRAWING

FIG. 1 shows an automated software license management system, according to invention principles.

FIG. 2 shows a flowchart of a process employed by an automated software license management system, according to invention principles.

FIGS. 3 and 4 shows user interface display images presenting a form enabling a user to initiate a request for software, according to invention principles.

FIGS. 5 and 6 show user interface display image windows indicating a software license inventory before and after a license is automatically reclaimed, according to invention principles.

FIGS. 7A and 7B shows software source code for automatically managing reclamation of unused software applications and associated licenses, according to invention principles.

FIG. 8 shows a flowchart of a process performed by an automated software license management system, according to invention principles.

### DETAILED DESCRIPTION OF THE INVENTION

An automated software license management system automatically distributes software to requestors without manual intervention by evaluating requests for software and determining authorization status of a requester. If it is determined a requester is authorized, the system allows user access to shared directories to initiate software installation or alternatively initiates a call to a third-party software distribution application to push the software to the requester. Thereby software is distributed to authorized requestors (or a requester is allowed access to a software folder to download or use software). Concurrently, a user interface display image indicates software that is already licensed to the requestor and prompts the requestor to affirm continued need of software licenses so that licenses no longer needed are automatically reclaimed and an associated license tracking database is automatically updated and one license object, for example, is subtracted for the requestor.

A processor, as used herein, operates under the control of an executable application to (a) receive information from an input information device, (b) process the information by manipulating, analyzing, modifying, converting and/or transmitting the information, and/or (c) route the information to an output information device A processor may use, or comprise the capabilities off, a controller or microprocessor, for example. The processor may operate with a display processor or generator. A display processor or generator is a known element for generating signals representing display images or portions thereof. A processor and a display processor may comprise a combination of, hardware, firmware, and/or software.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A user interface (UI), as used herein, comprises one or more display images, generated by a display processor enabling user interaction with a processor or other device and associated data acquisition and processing functions. The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of the executable procedure or executable application manipulates the UI display images in response to the signals received from the input devices. In this way, the user interacts with the display image using the input devices, enabling user interaction with a processor or other device. The activities herein may he performed automatically or wholly or partially in response to user command. An automatically performed activity is performed in response to machine instruction or operation without direct user interaction in initiating the activity.

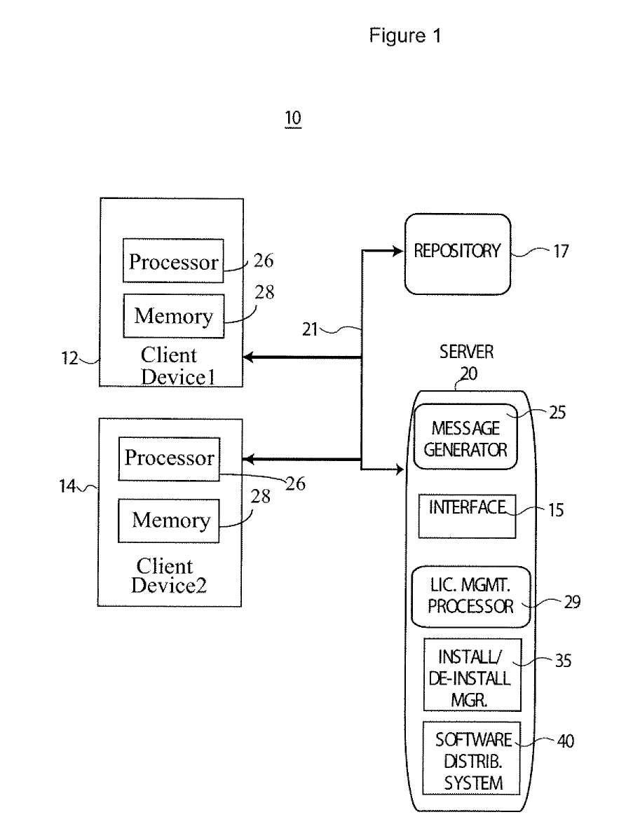

FIG. 1 shows automated software license management system 10. License management system 10 includes client devices (workstations) 12 and 14, repository 17 and server 20. Repository 17 (comprising one or more local or remote databases) includes information identifying licensed users of a first executable application. Server 20 includes message generator 25 that automatically initiates generation of a prompt message for communication to a user prompting a user to affirm continued need to use the first executable application in response to a predetermined event. Interface 15 receives answer data in response to the prompt message. License management processor 29 updates the information in repository 17 to indicate a user is no longer licensed to use the first executable application in response to the received answer data. Installation (and un-installation) manager 35 initiates un-installation of the first executable application in response to a local or remote user command. Software distribution system 40 automatically initiates communication of a second executable application to a destination in response to a received user request for the second executable application.

Server 90 and its supported processors as well as repository 17 may comprise multiple servers, processing devices and databases accessible and communicating via network 71, for example. The system 10 devices are interconnected and bidirectionally communicate via network 21 such as a LAN (Local Area Network) or other type of network. A client device (workstation) 12 or 14 includes processor 26 and memory unit 28 and may comprise a personal computer, for example. A user is able to view and manage software license information derived from repository 17 and software distribution via one or more user interface images displayed on client device 12 or 14.

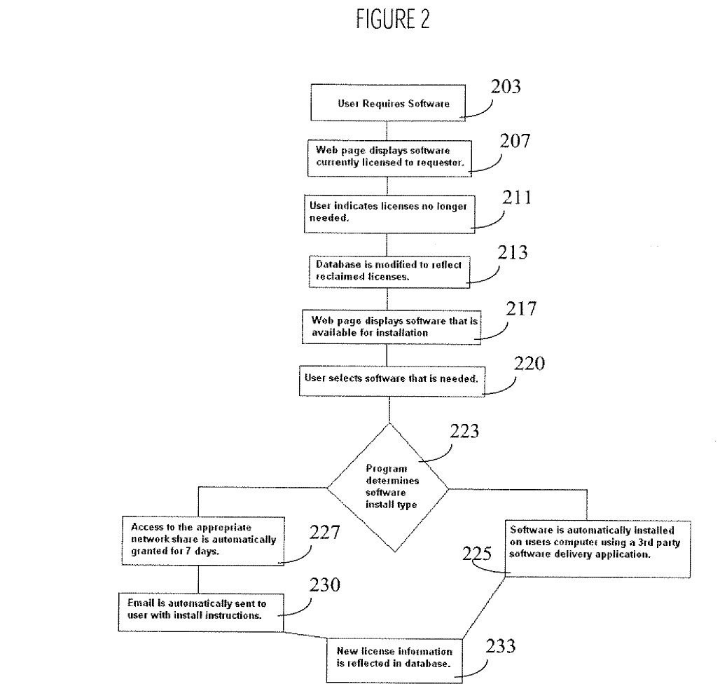

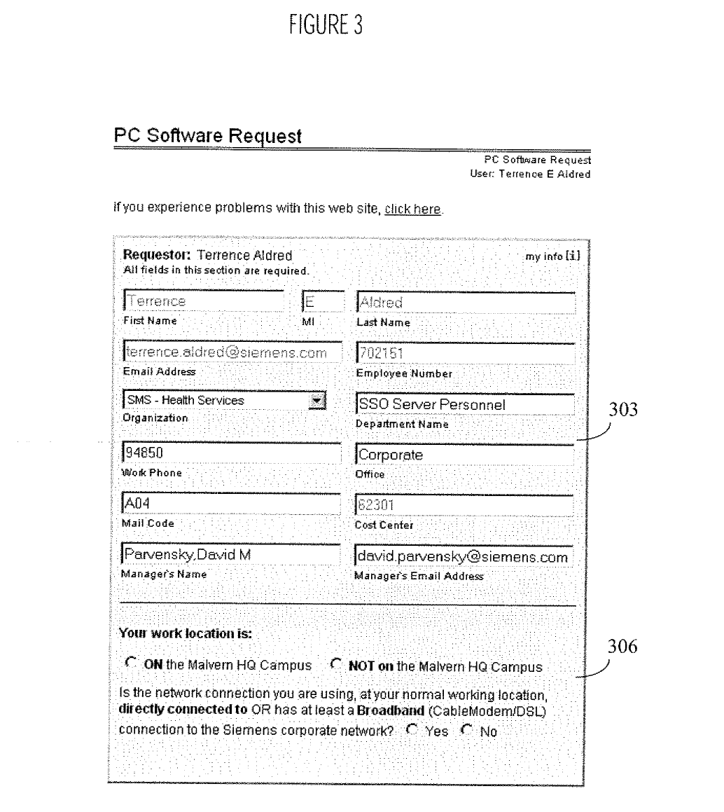

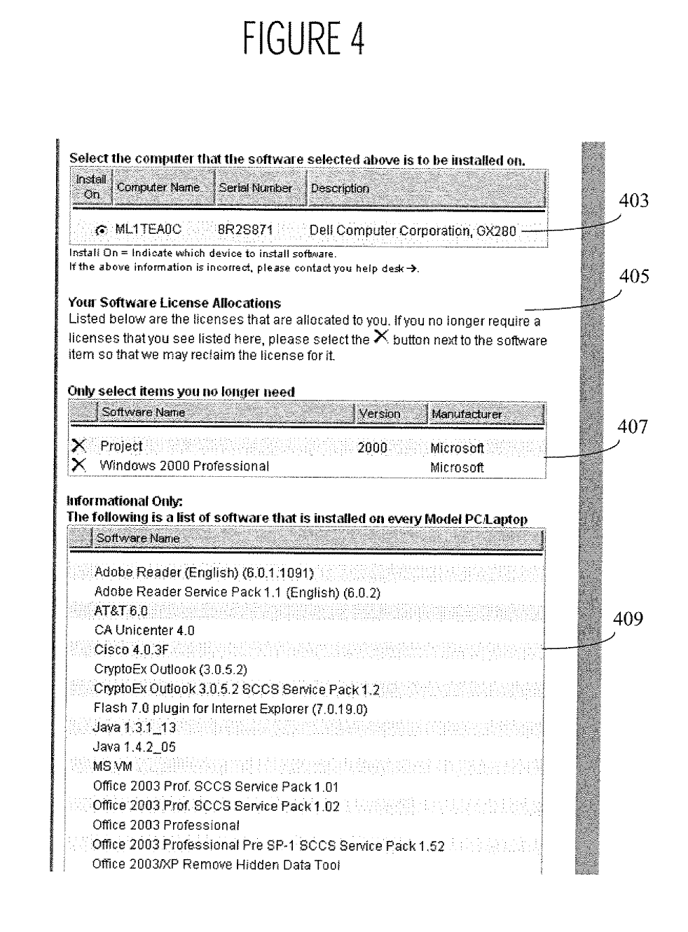

FIG. 2 shows a flowchart of a process employed by automated software license management system 10. Software distribution system 40 automatically initiates display of a web page on workstation 12 in step 207 identifying software that is already licensed to a user and requiring the user to affirm continued need of licenses in response to a user request to be provided with a software application via workstation 12 in step 203. FIGS. 3 and 4 shows user interface display images presenting a form on workstation 12 in step 203, enabling a user to initiate a request for software. Data fields in the form of FIGS. 3 and 4 may be pre-populated with data derived from stored user specific data in repository 17. In FIG. 3 image area 303 includes data fields for user (software requester) entry of user specific information including name, contact and address information and image area 306 enables user entry of user location associated information. In FIG. 4 a user selects data identifying a particular computer in image area 403 in which requested software is to be installed image areas 405 and 407 show existing software applications of a user and enable a user to select software applications and associated licenses that are no longer needed. The software no longer needed is un-installed by installation manager 35 and the licenses are relinquished as indicated by update of license tracking information in repository 17. Image area 409 shows a list of software applications installed on a user computer for user information.

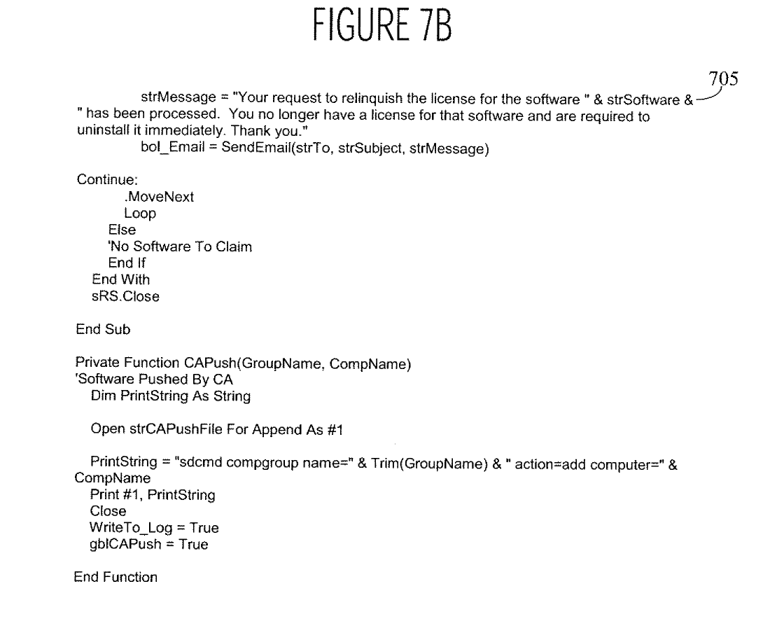

FIGS. 7A and 78 shows software source code executed by units 29 and 35 (FIG. 1) for automatically managing reclamation of unused software applications and associated licenses. Specifically, FIG. 7A shows code (e.g., from line 703) for automatically presenting a list of software available to a user and enabling a user to select individual applications that are no longer needed and are to be relinquished. The code also automatically updates a license tracking database to update counts of issued licenses and available licenses. The code of FIG. 7B (e.g., from line 705) prompts a user to uninstall the relinquished applications. In another embodiment installation manager 35 automatically uninstalls the relinquished applications.

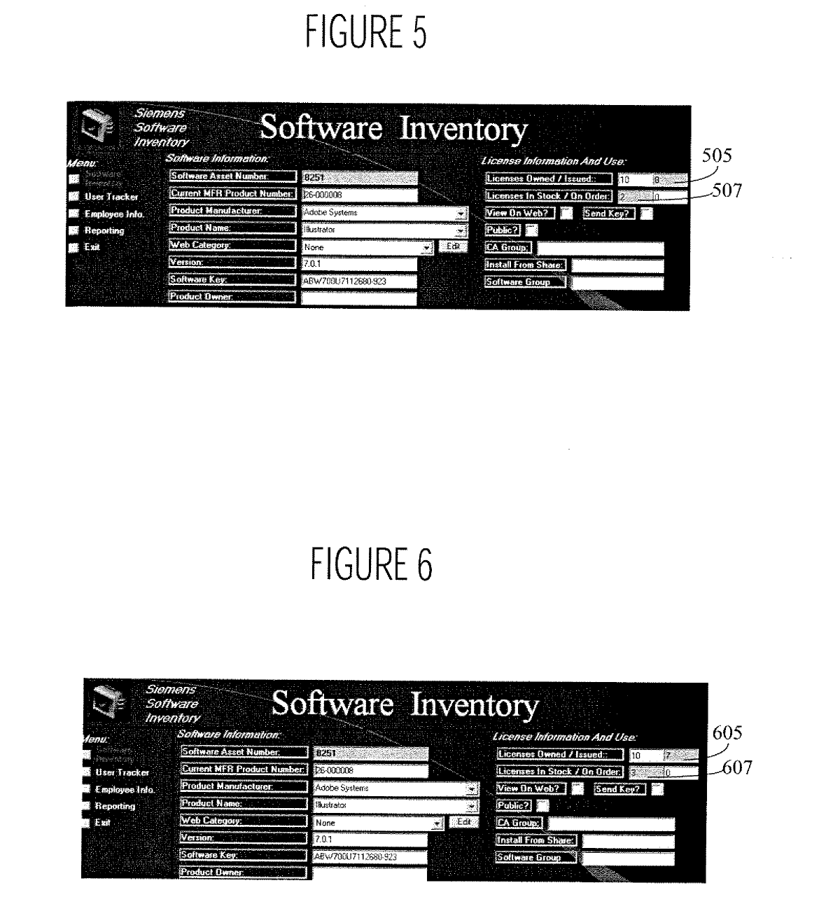

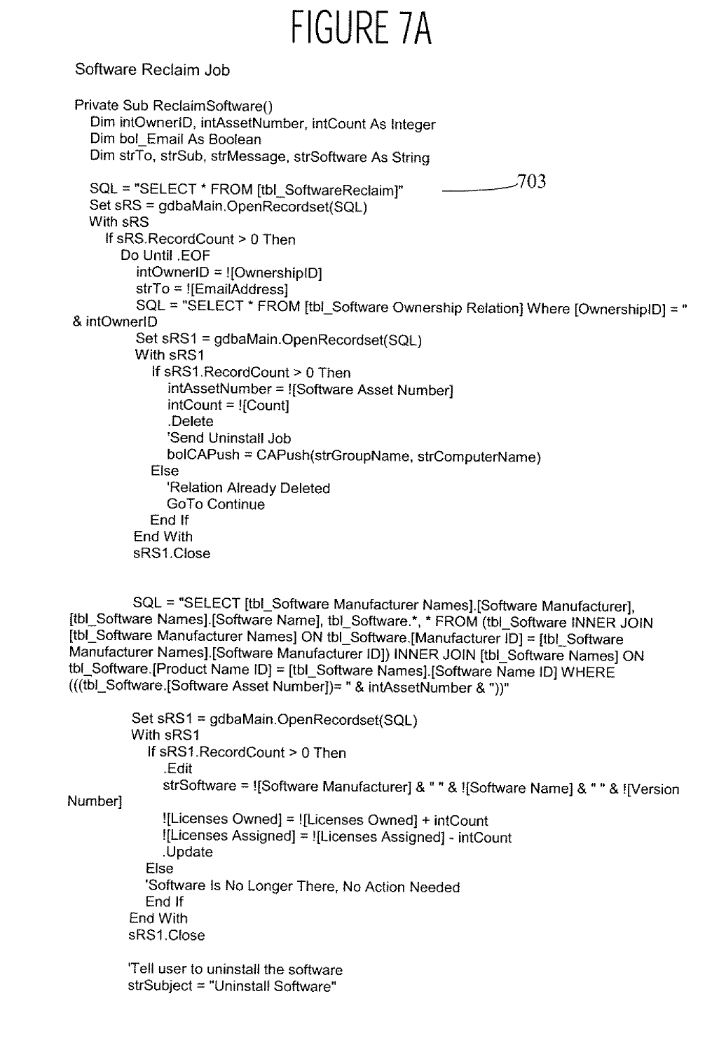

In step 213 (FIG. 2) license management processor 29 (FIG. 1) updates information in repository 17 to reflect reclaimed licenses and to indicate a user is no longer licensed to use an executable application in response to user entered data received in step 211 indicating a license is no longer needed. FIGS. 5 and 6 show user interface display image windows indicating a software license inventory maintained in repository 17 before and after a license is automatically reclaimed. Data fields 505 and 507 of FIG. 5 show an inventory of eight issued licenses and two available licenses. Upon relinquishment of a license and update of the inventory of license tracking information in repository 17, corresponding data fields 605 and 607 in FIG. 6 show seven issued licenses and three available licenses.

In step 217 license management processor 29 initiates generation of a web page for display on workstation 12 indicating software applications available for installation and in step 220 a user selects a particular application for installation from the available applications. In step 223 installation manager 35 determines a type of the selected particular application for installation, e.g., from a filename extension, file directory name or application metadata. In response to a determined type installation manager 35 performs either step 225 or steps 227 and 230. In step 225 installation manager 35 automatically installs the selected particular application on a user computer (e.g., workstation 12) using a third party (or proprietary) software distribution system 40. Alternatively in steps 227 and 230 installation manager 35 automatically grants a user access to a store enabling a user to download the selected particular application for a limited predetermined time period (e.g., seven days) and emails a user installation instructions. Following steps 225 and 230 license management processor 29 in step 233 updates the information in repository 17 to indicate a user is granted a license to use the selected particular application and the process of FIG. 2 terminates.

System 10 in one embodiment advantageously removes a need for manual intervention in the software request, user authorization determination and software delivery process. Further, system 10 automatically updates a license tracking database and queries a user for continued need of currently allocated licenses. The system further reduces administrative overhead related to software license tracking, and software delivery in response to user request. An organization uses system 10 to satisfy user requests for software, eliminating a need for manual intervention to authorize the request and enable delivery of software and update of license tracking database 17. An organization also realizes savings by identifying and reclaiming unused licenses. In a further example of operation, a user needing a software application logs into a web page of a website and is automatically presented with data identifying licenses the user already has and is automatically prompted to relinquish un-needed licenses. The user navigates to a request section of a web page and selects a desired software application. The user and a supervisor are sent a confirmation e-mail indicating the request for the desired software application. In response to processing the software application request, the user receives an email indicating access has been granted and the software application may he installed. Alternatively, the software application may be automatically pushed directly to a user computer and automatically installed (e.g., using a third party or proprietary software pushing application).

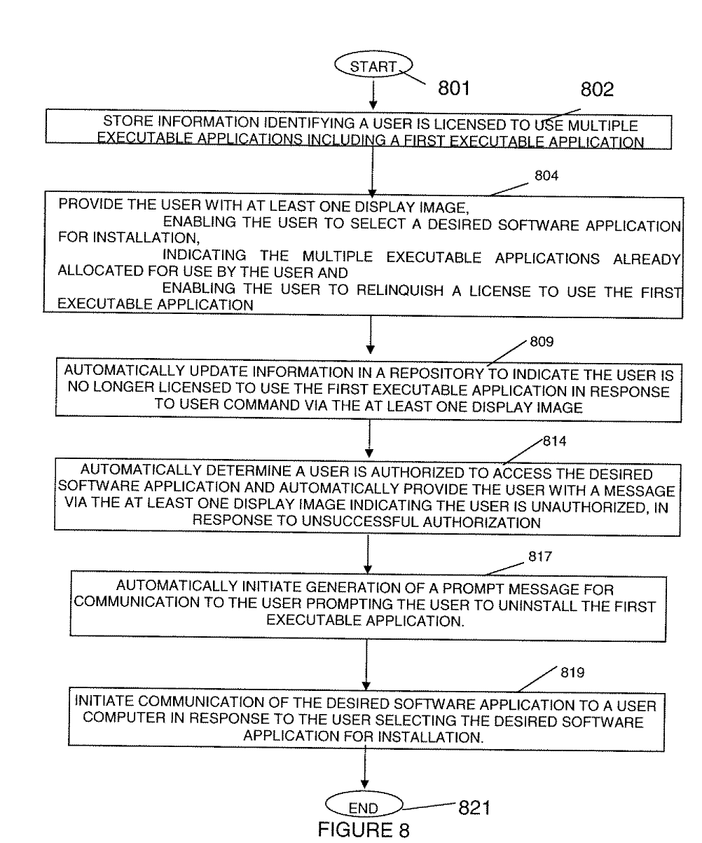

FIG. 8 shows a flowchart of a process performed by automated software license management system 10 (FIG. 1). The steps of FIG. 8 may be performed automatically except where identified as being exclusively manual. In step 802 following the start at step 801, information is stored in repository 17 identifying that a user is licensed to use multiple particular executable applications including a first executable application and information identifying the licensed users of a first executable application. In step 804 a user interface in workstation 12 provides the user with display images. The user interface is an Internet browser interface and the display images comprise web pages including one or more forms, for example. One or more of the display images, enables the user to select a desired software application for installation, indicate the multiple executable applications already allocated for use by the user, identifies a user computer, enables the user to relinquish a license to use the first executable application and select the first executable application of the multiple executable applications for un-installation. License management processor 29 in step 809 automatically updates the information in repository 17 to indicate the user is no longer licensed to use the first executable application in response to user command via the display images.

In one embodiment, message generator 25 automatically initiates generation of a prompt message for communication to the user prompting the user to affirm continued need to use the first executable application in response to a predetermined event. The predetermined event comprises at least one of, a request for new software (e.g. for a second executable application to be installed), an intermittently communicated interrogation message, a request for a hardware change and a planned or actual hardware change, for example. Interface 15 receives answer data in response to the prompt message and license management processor 29 automatically updates the information in repository 17 in response to the received answer data. Installation manager 35 automatically initiates un-installation of the first executable application in response to at least one of the answer data, a local user command and a remote user command.

In step 814 an authorization processor in installation manager 35 automatically determines a user is authorized to access the desired software application and automatically provides the user with a message via the display images indicating the user is unauthorized, in response to unsuccessful authorization. The authorization processor also inhibits user access to the desired software application, in response to unsuccessful authorization. The authorization processor in addition, automatically initiates generation of a message to an authorizing entity indicating the user requested to use the desired executable application and also initiates providing the user with a message via the display images indicating the user is unauthorized, in response to the authorizing entity denying the request. Message generator 25 in step 817 automatically initiates generation of a prompt message for communication to the user prompting the user to uninstall the first executable application. In one embodiment installation manager 35 automatically initiates un-installation of the first executable application in response to the user selecting the first executable application of the multiple executable applications for un-installation. Software distribution system 40 in step 819 automatically initiates communication of the desired software application (a second executable application) to a user computer (a destination) in response to the user selecting the desired software application for installation. The process of FIG. 8 terminates at step 821.

The system, processes and image displays of FIGS. 1-8 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. An automated software distribution and license management system in accordance with invention principles may be used wherever software is distributed or un-installed. The processes and applications operating on server 20 (FIG. 1) may in alternative embodiments, be located on one or more (e.g., distributed) processing devices accessing the network shown in FIG. 1 or remotely accessible from this network. Further, any of the functions and steps provided in FIGS. 1-8 may be implemented in hardware, software or a combination of both and may reside on one or more processing devices located at any location of a network linking the FIG. 1 elements or another linked network including another intra-net or the Internet.

What is claimed is:

1. An automated software license management system, comprising:
at least one repository of information identifying licensed users of a first executable application;
a message generator for automatically initiating generation of a prompt message for communication to a user prompting a user to affirm continued need to use said first executable application in response to a predetermined event;
an interface for receiving answer data in response to said prompt message; and
a license management processor for automatically updating said information in said at least one repository to indicate a user is no longer licensed to use said first executable application in response to said received answer data.

2. A system according to claim 1, wherein
said predetermined event comprises at least one of, (a) a request for new software, (b) an intermittently communicated interrogation message.

3. A system according to claim 1, wherein
said predetermined event comprises at least one of, (a) a request for a software version upgrade, (b) a planned or actual software version upgrade.

4. A system according to claim 1, wherein
said predetermined event comprises at least one of, (a) a request for a hardware change, (b) a planned or actual hardware change.

5. A system according to claim 1, including
a un-installation manager for automatically initiating un-installation of said first executable application in response to said answer data.

6. A system according to claim 1, including
a un-installation manager for initiating un-installation of said first executable application in response to at least one of, (a) a local user command and (b) a remote user command.

7. A system according to claim 1, including
a software distribution system for automatically initiating communication of a second executable application to a destination in response to a received user request for said second executable application.

8. A system according to claim 7, wherein
said message generator automatically initiates generation of said prompt message for communication to said user in response to said received user request for said second executable application.

9. An automated software distribution and license management system, comprising:
a repository of information identifying a user is licensed to use a plurality of executable applications including a first executable application;
a user interface for providing said user with at least one display image, said at least one display image,
enabling said user to select a desired software application for installation,
indicating said plurality of executable applications already allocated for use by said user and
enabling said user to relinquish a license to use said first executable application; and
a license management processor for automatically updating said information in said repository to indicate said user is no longer licensed to use said first executable application in response to user command via said at least one display image.

10. A system according to claim 9, wherein
said user interface is an Internet browser interface and said at least one display image comprises a web page including a form.

11. A system according to claim 9, including
a software distribution system for automatically initiating communication of said desired software application to a user computer in response to said user selecting said desired software application for installation.

12. A system according to claim 11, wherein
said at least one display image includes information identifying said user computer.

13. A system according to claim 9, wherein
said at least one display image enables said user to select said first executable application of said plurality of executable applications for un-installation.

14. A system according to claim 13, including
a message generator for automatically initiating generation of a prompt message for communication to said user prompting said user to uninstall said first executable application.

15. A system according to claim 13, including
an un-installment manager for automatically initiating un-installation of said first executable application in response to said user selecting said first executable application of said plurality of executable applications for un-installation.

16. A system according to claim 9, including
an authorization processor for automatically determining a user is authorized to access said desired software application and automatically providing said user with a message via said at least one display image indicating said user is unauthorized, in response to unsuccessful authorization.

17. A system according to claim 16, wherein
said authorization processor inhibits user access to said desired software application, in response to unsuccessful authorization.

18. A system according to claim 9, including
an authorization processor for automatically initiating generation of a message to an authorizing entity indicating said user requested to use said desired executable application and initiating providing said user with a message via said at least one display image indicating said user is unauthorized, in response to said authorizing entity denying the request.

19. An automated software distribution and license management system, comprising.
a repository of information identifying a user is licensed to use a plurality of executable applications including a first executable application;
a user interface for providing said user with at least one display image, said at least one display image,
enabling said user to select a desired software application for installation,
indicating said plurality of executable applications already allocated for use by said user and
enabling said user to relinquish a license to use said first executable application; and
a license management processor for automatically updating said information in said repository to indicate said user is no longer licensed to use said first executable application in response to user command via said at least one display image;
an authorization processor for automatically determining a user is authorized to access said desired software application and automatically providing said user with a message via said at least one display image indicating said user is unauthorized, in response to unsuccessful authorization; and
a software distribution system for initiating communication of said desired software application to a user computer in response to said user selecting said desired software application for installation.

20. A system according to claim 19, including
a message generator for automatically initiating generation of a prompt message for communication to said user prompting said user to uninstall said first executable application.
